(19) United States
(12) Patent Application Publication
(10) Pub. No.: US 2026/0110863 A1
(43) Pub. Date: Apr. 23, 2026

(54) FLEXIBLE OPTICAL FIBER RIBBON AND OPTICAL CABLE

(71) Applicant: YANGTZE OPTICAL FIBRE AND CABLE JOINT STOCK LIMITED COMPANY, Hubei (CN)

(72) Inventors: Jun HUANG, Hubei (CN); Haifeng HU, Hubei (CN); Fan WU, Hubei (CN); Lei ZHENG, Hubei (CN); Yifan CHU, Hubei (CN); Hao LU, Hubei (CN); Lin QI, Hubei (CN); Xiangrong YANG, Hubei (CN); Zhuang XIONG, Hubei (CN)

(73) Assignee: YANGTZE OPTICAL FIBRE AND CABLE JOINT STOCK LIMITED COMPANY, Hubei (CN)

(21) Appl. No.: 19/424,014

(22) Filed: Dec. 17, 2025

Related U.S. Application Data
(63) Continuation of application No. PCT/CN2024/112746, filed on Aug. 16, 2024.

(30) Foreign Application Priority Data
Dec. 20, 2023 (CN) 202311759760.6
Jun. 24, 2024 (CN) 202421448566.6

(51) Int. Cl. G02B 6/44

(52) U.S. Cl. CPC G02B 6/4403

(57) ABSTRACT

Flexible optical fiber ribbon includes multiple optical fibers. The multiple optical fibers are optical fibers arranged side by side, and multiple bonded portions are arranged between adjacent optical fibers and distributed intermittently along the longitudinal direction, the multiple bonded portions being made of the same material; each optical fiber has a ink layer at the underlying outermost layer and a transparent coating layer at the outermost layer; the transparent coating layers of the multiple optical fibers are made of the same material, and the transparent coating layers are continuous in the axial direction and continuous in the circumferential direction; the colors and/or shapes of the ink layers of optical fibers are observed through the transparent coating layers, and there is at least one optical fiber, among the multiple optical fibers, of which the color and/or shape of the ink layer thereof is different from that of another optical fiber among the multiple optical fibers.

### CROSS-REFERENCE TO RELATED APPLICATION

This application is a continuation of international application of PCT application serial no. PCT/CN2024/112746 filed on Aug. 16, 2024, which claims the priority benefit of China application no. 202311759760.6 filed on Dec. 20, 2023 and China application no. 202421448566.6 filed on Jun. 24, 2024. The entirety of each of the above mentioned patent applications is hereby incorporated by reference herein and made a part of this specification.

### TECHNICAL FIELD

The present disclosure relates to optical fiber communication, and more specifically, relates to a flexible optical fiber ribbon and an optical cable.

### DESCRIPTION OF RELATED ART

In a flexible optical fiber ribbon, there are bonded portions intermittently arranged between adjacent optical fibers. The bonded portions are created by a device that systematically applies a bonding material or an adhesive between the optical fibers. By “intermittently”, it means that not all adjacent optical fibers have bonded portions therebetween. To identify the optical fibers, each optical fiber within the same flexible optical fiber ribbon is colored or marked differently. The ink layer of the optical fiber is formed by mixing color masterbatch into resin, which is then coated or partially coated on a side surface of the optical fiber.

Due to the varying impact of different pigment colors on the physicochemical properties of resin, it becomes challenging to regulate the adhesive force uniformly between different optical fibers and the bonded portions within the same optical fiber ribbon when the bonding material or adhesive forms intermittently arranged bonded portions. This discrepancy may result in some optical fibers becoming more prone to debonding or more difficult to separate compared to others, thereby affecting the quality or performance of optical cables utilizing the flexible optical fiber ribbons.

### SUMMARY

In view of the above defects or needs for improvement of the related technology, the present disclosure provides a flexible optical fiber ribbon and an optical cable.

To achieve the above purpose, according to an aspect of the present disclosure, a flexible optical fiber ribbon is provided, including a plurality of optical fibers, the plurality of optical fibers being optical fibers arranged side by side, with a plurality of bonded portions arranged between the adjacent optical fibers and distributed intermittently along the longitudinal direction, the plurality of bonded portions being made of the same material;

Each of the optical fibers has a ink layer at an underlying outermost layer and a transparent coating layer at an outermost layer;

The transparent coating layers of the plurality of different optical fibers are made of the same material, and the transparent coating layers of the same optical fibers are continuous in the axial direction and continuous in a circumferential direction;

The colors and/or shapes of the ink layers of the optical fibers are observed through the transparent coating layers, and there is at least one optical fiber, among the plurality of optical fibers, of which the color and/or shape of the ink layer thereof is different from that of another optical fiber among the plurality of optical fibers.

Preferably, in the flexible optical fiber ribbon, the color and/or shape of the ink layer of any optical fiber among the plurality of optical fibers is different from that of another optical fiber among the plurality of optical fibers, to serve as a unique marking for that optical fiber.

Preferably, in the flexible optical fiber ribbon, a thickness of the ink layer is 1 μm to 15 μm. A modulus of the ink layer is greater than a modulus of the transparent coating layer. The shape of the ink layer is continuous or discontinuous in the circumferential direction. The shape of the ink layer is continuous or discontinuous in the axial direction. A material of the ink layer is a UV-curable ink.

Preferably, in the flexible optical fiber ribbon, a visible light transmittance of the transparent coating layer is 85% or more, a visible light transmittance of the ink layer is 30% or less, and a visible light transmittance of the bonded portions is 50% or less.

Preferably, a thickness of the transparent coating layer is greater than or equal to D/2, where D is a bond width threshold bonded portions.

Preferably, in the flexible optical fiber ribbon, the thickness of the transparent coating layer is 10 μm to 100 μm. The modulus of the transparent coating layer is greater than 50 MPa. An outer contour of the transparent coating layer is circular. The material of the transparent coating layer and a matrix of the ink layer and/or the bonded portions are the same type of resin.

Preferably, in the flexible optical fiber ribbon, the thickness of the transparent coating layer is 10 μm to 50 μm.

Preferably, in the flexible optical fiber ribbon, the modulus of the transparent coating layer is greater than 500 MPa, and the material thereof is a UV-curable resin; the modulus of the ink layer is greater than 600 MPa, and the material thereof is a UV-curable ink.

Preferably, in the flexible optical fiber ribbon, the material of the bonded portions is a photocurable resin, and the bonded portions are continuous or discontinuous in an arrangement direction of the optical fiber.

According to another aspect of the present disclosure, an optical cable is provided, which includes an outer sheath and the flexible optical fiber ribbon provided by the present disclosure, wherein the flexible optical fiber ribbon is accommodated in the outer sheath.

Overall, the above technical solutions conceived by the present disclosure may achieve the following advantageous effects compared to related technologies:

The present disclosure provides a flexible optical fiber ribbon, ensuring consistent bonding strength between each optical fiber and the bonded portion within the optical fiber ribbon by covering the exterior of the ink layer of the plurality of optical fibers with a transparent coating layer of the same material. In a preferred embodiment, the bonding strength of the bonded portion of the optical fiber is simplified from a combination of adhesive resin and a plurality of colored resin surfaces to a combination of adhesive resin and highly transparent resin. There is no need to consider the impact of different optical fiber coloring pigments on the bonding strength between the optical fiber coating and the bonding portion, thereby reducing the difficulty in controlling the subtle balance between the bonding strength and the tearing strength, which poses challenges in material development, manufacturing, and ribbon processing. This improvement enhances the consistency of the bonding strength between the optical fibers and the bonded portion within the flexible optical fiber ribbon, contributing to the stability of product quality.

### BRIEF DESCRIPTION OF THE DRAWINGS

FIG. 1 is a plan schematic diagram of a flexible optical fiber ribbon provided by an embodiment of the present disclosure;

FIG. 2 is schematic diagram of an end surface of a flexible optical fiber ribbon provided by an embodiment of the present disclosure;

FIG. 3 is a structural diagram of an optical cable of a flexible optical fiber ribbon provided by an embodiment of the present disclosure;

FIG. 4 is a plan schematic diagram of a flexible optical fiber ribbon with bonded portions arranged continuously in an arrangement direction of the optical fiber provided by an embodiment of the present disclosure;

FIG. 5 is a structural diagram of a ink layer of an optical fiber colored stripe provided by Embodiment 2 of the present disclosure;

FIG. 6 is a structural diagram of a ink layer of an optical fiber color ring provided by Embodiment 2 of the present disclosure;

FIG. 7 is a structural diagram of a ink layer of an optical fiber spot provided by Embodiment 2 of the present disclosure.

In all the accompanying drawings, identical reference numerals are used to denote identical components or structures, wherein: 1 denotes the optical fiber, 2 denotes the bonded portion, 3 denotes the glass portion of the optical fiber, 4 denotes the uncoated optical fiber resin, 5 denotes the ink layer, 6 denotes the transparent coating layer, 7 denotes the water-blocking element, 8 denotes the protective structure, 9 denotes the tensile element, and 10 denotes the outer sheath.

### DESCRIPTION OF THE EMBODIMENTS

In order to make the objectives, technical solutions and advantages of the present disclosure clearer, the present disclosure is described in further detail below in combination with embodiments. It should be understood that the specific embodiments described herein are only used to explain the present disclosure and are not used to limit the present disclosure. In addition, the technical features involved in the various embodiments of the present disclosure described below may be combined with each other as long as they do not constitute conflicts with each other.

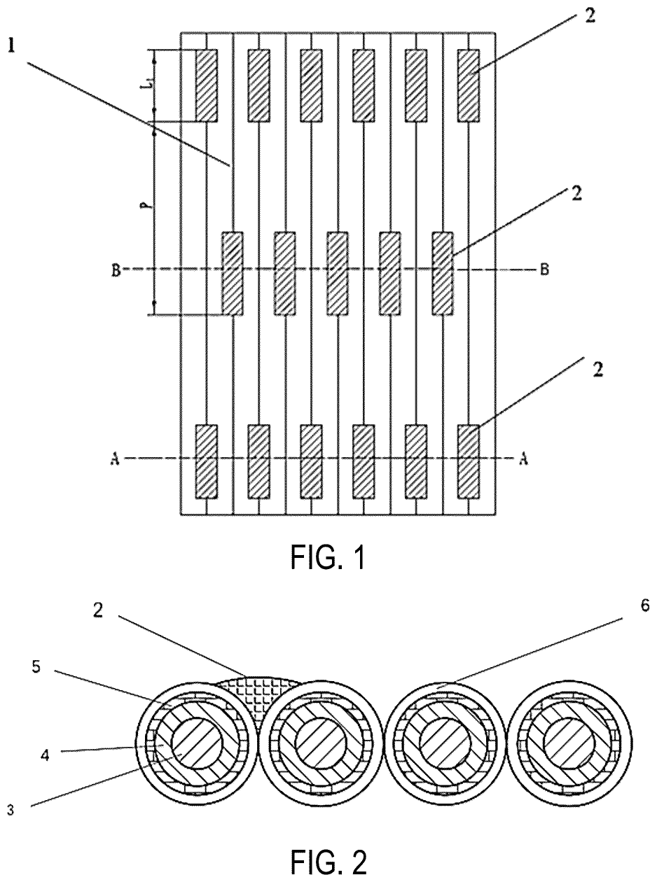

A flexible optical fiber ribbon provided by the present disclosure, as shown in FIG. 1, includes a plurality of optical fibers. The plurality of optical fibers are optical fibers arranged side by side, with a plurality of bonded portions arranged between the adjacent optical fibers and distributed intermittently along the longitudinal direction. The plurality of bonded portions are made of the same material;

Each of the optical fibers has a ink layer at an underlying outermost layer and a transparent coating layer at an outermost layer;

The transparent coating layers of the plurality of different optical fibers are made of the same material, and the transparent coating layers of the same optical fibers are continuous in the axial direction and continuous in a circumferential direction, preferably with a circular outer contour;

The colors and/or shapes of the ink layers of the optical fibers are observed through the transparent coating layers, and there is at least one optical fiber, among the plurality of optical fibers, of which the color and/or shape of the ink layer thereof is different from that of another optical fiber among the plurality of optical fibers.

When the ink layers of two optical fibers have different colors or shapes, direct bonding performed through the bonded portion may cause the issue of inconsistent adhesion. By adopting the transparent coating layer to cover the optical fiber and performing bonding through the transparent coating layer with the same material as the bonded portion, such problem may be solved.

Typically, the shape and/or color differences between the ink layers of the optical fibers serve an identification function: the color and/or shape of the ink layer of any optical fiber among the plurality of optical fibers is different from that of another optical fiber among the plurality of optical fibers, to serve as a unique marking for that optical fiber.

The ink layer has a visible light transmittance of 30% or less, and the ink layer has a thickness of 1 μm to 15 μm. An excessively thin ink layer may cause the color to be too light, affecting identification efficiency. An excessively thick ink layer may compress the thickness of the resin that directly contacts the glass inside the ink layer, thereby affecting a bending additional loss and long-term durability of the optical fiber. A modulus of the ink layer is greater than a modulus of the transparent coating layer. When separating the optical fibers, the transparent coating layer may rupture prior to the ink layer, avoiding the ink layer being torn and affecting the identification effect after separating the optical fibers. The shape of the ink layer is continuous or discontinuous in the circumferential direction; The shape of the ink layer is continuous or discontinuous in the axial direction. Typically, the ink layer is continuous in both axial and circumferential directions, i.e., fully coated; the circumferentially discontinuous shape of the ink layer is like colored stripes; the axially discontinuous shape of the ink layer is like colored rings; The case where the ink layer is discontinuous in both circumferential and axial directions is like spots. Here, “axial direction” refers to a length direction of the optical fiber or the flexible optical fiber ribbon, and “circumferential direction” refers to a circumferential direction of the optical fiber. The modulus of the ink layer is greater than 600 Mpa, and a material thereof is a UV-curable resin.

The transparent coating layer exhibits a visible light transmittance rate of 85% or more, facilitating the easy observation of the color and shape of the ink layer by the naked eye, thus aiding in identification; The thickness of such layer ranges from 10 μm to 100 μm, with a preferred range of 10 μm to 50 μm. The thickness d of the transparent coating layer should be greater than or equal to D/2, where D represents a bond width threshold. The transparent coating layer at the outermost layer of the optical fiber serves as a signal detection sensor. When the transparent coating layer transmits a detection light, it means suboptimal bonding effectiveness of the bonded portion. Therefore, the thickness of the transparent coating layer determines the precision of detection—the greater the thickness, the higher the detection standard, thereby imposing more stringent requirements on the bonding effectiveness of the bonded portion, and vice versa. The overall strength of the transparent resin, post-coloring and after integrating with the bonding resin, forms the bonding strength between the optical fibers. A layer that is too thin results in lower overall strength, adversely affecting the stability of the optical fiber ribbon structure. Conversely, an excessively thick transparent coating layer compresses the thickness of the resin directly contacting the glass within the ink layer, potentially impacting the macro-bending loss and long-term durability of the optical fiber. The modulus of the transparent coating layer exceeds 50 MPa, preferably surpassing 500 MPa. The material of the transparent coating layer should be of the same resin type as the matrix of the ink layer and/or the bonded portion, preferably a UV-curable resin, which is the same type resin as the matrix of the ink layer. Such design ensures stable bonding between the ink layer and the transparent coating layer, which has the same type of resin as the bonded portion, and also ensures stable bonding between the transparent coating layer and the bonded portion. The modulus of the transparent coating layer is lower than that of the ink layer, allowing the transparent coating layer to fracture prior to the ink layer when the optical fibers are separated, thus preventing the tearing of the ink layer and preserving the identification efficacy post-separation.

The material of the bonded portion is a photocurable resin, and the bonded portion is continuous or discontinuous in the arrangement direction of the optical fiber. The visible light transmittance of the bonded portion is 50% or less.

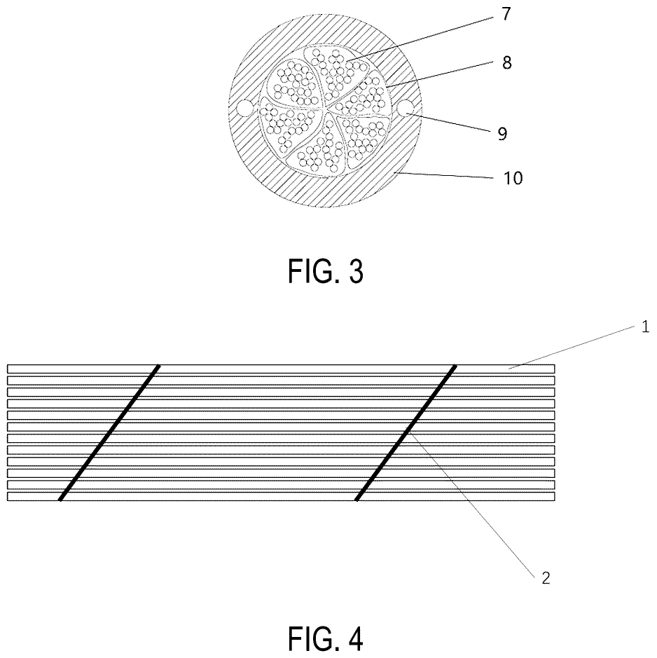

The optical cable provided by the present disclosure, as shown in FIG. 3, includes an outer sheath and the flexible optical fiber ribbon provided by the present disclosure, and when necessary, also includes:

A water-blocking element, such as water-blocking grease, water-blocking yarn, water-blocking tape, water-blocking powder;

A protective structure, such as a loose tube, a skeleton, a steel tape armored layer;

A tensile element, such as a center-reinforcing member, a phosphatized steel wire, a FRP rod.

The following are embodiments:

The flexible optical fiber ribbon provided in this embodiment consists of a 12-core optical fiber ribbon with a spacing of 250 μm between the centers of the optical fibers. The structure of the 250 μm ink-coated optical fiber used in this embodiment is as follows, as depicted in FIG. 2: a uncoated optical fiber with a diameter of 210 μm, wherein the glass portion has a diameter of 125 μm. The glass is coated with an inner and outer layer, giving it a coated diameter of 210 μm. Subsequently, an acrylic-based ink is applied for coloring, resulting in a ink layer with an outer diameter of 220 μm. An additional layer of approximately 15 μm thick acrylic photocurable high-transmittance resin is applied over the ink-coated optical fiber, with a light transmittance of 85% or more, thereby increasing the diameter of the optical fiber to 250 μm. This ink layer ensures that the transparent coating layer does not impede the differentiation of optical fibers via the ink layer. The light transmittance of the ink layer is 25%. The modulus of the high-transmittance photocurable resin is 550 Mpa, and the modulus of the transparent coating layer is lower than that of the ink layer, which has a modulus of 650 Mpa. When the optical fibers are separated, the transparent coating layer will fracture prior to the ink layer, preventing the ink layer from being torn and thus maintaining the identification efficacy after the optical fibers are separated.

The shapes of the ink layers of all 12 optical fibers adopts full coating that is continuous in both axial and circumferential directions, with each optical fiber having a different color, namely 12 optical fibers with standard colors, with optical fibers uniquely identified through color.

Adhesive resin is intermittently distributed between the optical fibers, namely the intermittently distributed bonded portions. At a position A-A, the bonded portions of a first arrangement are distributed, and at a position B-B, bonded portions of a second arrangement are distributed. A length L₁ of the adhesive resin is 5 mm to 20 mm, and a spacing P of the resin is 50 mm to 100 mm, as shown in FIG. 1.

The bonded portions may also be distributed intermittently along the longitudinal direction, as well as a structure with continuous distribution along the arrangement direction of the optical fiber, as illustrated in FIG. 4.

The photocurable resin used for making the bonded portions is preferably a UV curable resin. To meet the above requirements, oligomer, an active monomer diluent, a photoinitiator and additives are also included;

The composition includes 25 to 70 parts by mass of oligomers, 30 to 75 parts of active monomer diluents, 1 to 10 parts of photoinitiators, and 1 to 10 parts of additives. The additives include a silane coupling agent. The UV-curable resin contains 0.5 wt % to 5 wt % of the silane coupling agent. The silane structure is preferably incorporated into the resin material through crosslinking, but the silane structure may also be added in the form of additives, which might affect the ultimate curability and, consequently, the long-term service life of the resin. The additives further include a defoaming agent, a leveling agent, and an antioxidant.

The oligomer is a composition containing polyurethane acrylate and epoxy acrylate; wherein the polyurethane acrylate is preferably aliphatic polyurethane acrylate and/or aromatic polyurethane acrylate.

The active monomer diluent is a monofunctional active diluent and/or a multifunctional active diluent. The functional active diluent is preferably β-hydroxyethyl methacrylate; the multifunctional active diluent is preferably one or more selected from the group consisting of 1,6-hexanediol diacrylate, isobornyl acrylate, trimethylolpropane formal acrylate, neopentyl glycol diacrylate, dipropylene glycol diacrylate, tripropylene glycol diacrylate, trimethylolpropane triacrylate, trimethylolpropane trimethacrylate, pentaerythritol triacrylate, tricyclodecane dimethanol diacrylate. The use of monomers containing more functional groups, in addition to increasing the reaction activity, may also impart a crosslinked structure to a cured film.

The silane coupling agent is a silane structure organosilicon compound, which is one or more selected from the group consisting of α-[3-(2′-hydroxyethoxy) propyl]-ω-trimethyl methylsilicon alkoxy polydimethyl siloxane, α-[3-(2′-hydroxyethoxy) propyl]-ω-trimethyl methylsilicon alkoxy polydiphenyl siloxane, α-[3-(2′,3′-dihydroxypropoxy) propyl]-ω-trimethyl methylsilicon alkoxy polydimethyl siloxane, α-[3-(2′,3′-dihydroxypropoxy) propyl]-ω-trimethyl methylsilicon alkoxy polydiphenyl siloxane, α-[3-(2′-ethyl-2′-hydroxymethyl-3-hydroxyl) propyl]-ω-trimethyl methylsilicon alkoxy polydimethyl siloxane, α-[3-(2′-ethyl-2′-hydroxymethyl-3-hydroxyl) propyl]-ω-trimethyl methylsilicon alkoxy polydiphenyl siloxane, α-[3-(2′-hydroxyl-3′-isopropylamino) propyl]-ω-trimethyl methylsilicon alkoxy polydimethyl siloxane, and α-[3-(2′-hydroxyl-3′-isopropylamino) propyl]-ω-trimethyl methylsilicon alkoxy polydiphenyl siloxane.

### Embodiment 2

The structure of this embodiment is similar to Embodiment 1, with the difference being that the ink layer of the 12-core optical fiber adopts three primary colors. Each color of the optical fiber is available in four different ink layer shapes, namely:

Full coating that is continuous in axial and circumferential directions;

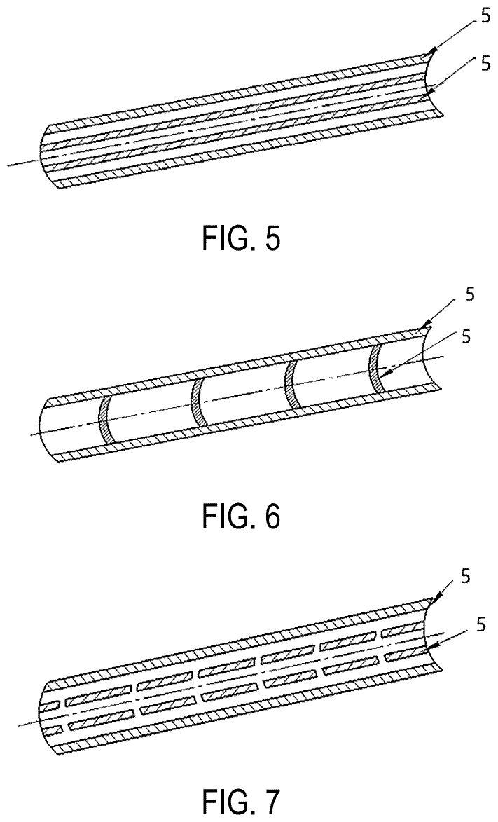

Colored stripes that are continuous in the axial direction and discontinuous in the circumferential direction, as shown in FIG. 5;

Colored rings that are discontinuous in the axial direction and continuous in the circumferential direction, as shown in FIG. 6;

Spots that are discontinuous in the axial direction and the circumferential direction, as shown in FIG. 7.

The uniqueness identification of the optical fibers is achieved through the combination of the shape and color arrangement of the ink layers of the 12-core optical fibers. The use of fewer colors reduces the complexity of material development. The transparent coating layer is applied using a full-coating process, naturally forming and filling the discontinuous parts of the ink layers, thus maintaining a smooth appearance.

Those skilled in the art can easily understand that the above are only preferred embodiments of the present disclosure and are not intended to limit the present disclosure. Any modifications, equivalent substitutions and improvements made within the spirit and principles of the present disclosure shall be included within the scope to be protected by the present disclosure.

What is claimed is:

1. A flexible optical fiber ribbon, comprising a plurality of optical fibers, the plurality of optical fibers being optical fibers arranged side by side, with a plurality of bonded portions arranged between the adjacent optical fibers and distributed intermittently along the longitudinal direction, the plurality of bonded portions being made of a same material;
wherein each of the optical fibers has a ink layer at an underlying outermost layer and a transparent coating layer at an outermost layer;
the transparent coating layers of the plurality of different optical fibers are made of the same material, and the transparent coating layers of the same optical fibers are continuous in the axial direction and continuous in a circumferential direction;
colors and/or shapes of the ink layers of the optical fibers are observed through the transparent coating layers, and there is at least one optical fiber, among the plurality of optical fibers, of which the color and/or shape of the ink layer thereof is different from that of another optical fiber among the plurality of optical fibers.

2. The flexible optical fiber ribbon according to claim 1, wherein the color and/or shape of the ink layer of any optical fiber among the plurality of optical fibers is different from that of another optical fiber among the plurality of optical fibers, to serve as a unique marking for that optical fiber.

3. The flexible optical fiber ribbon according to claim 1, wherein a thickness of the ink layer is 1 μm to 15 μm, a modulus of the ink layer is greater than a modulus of the transparent coating layer, the shape of the ink layer is continuous or discontinuous in the circumferential direction, the shape of the ink layer is continuous or discontinuous in the axial direction, a material of the ink layer is a UV-curable ink.

4. The flexible optical fiber ribbon according to claim 1, wherein a visible light transmittance of the transparent coating layer is 85% or more, a visible light transmittance of the ink layer is 30% or less, and a visible light transmittance of the bonded portions is 50% or less.

5. The flexible optical fiber ribbon according to claim 1, wherein a thickness of the transparent coating layer is greater than or equal to D/2, where D is a bond width threshold bonded portions.

6. The flexible optical fiber ribbon according to claim 5, wherein the thickness of the transparent coating layer is 10 μm to 100 μm, a modulus of the transparent coating layer is greater than 50 MPa, an outer contour of the transparent coating layer is circular, a material of the transparent coating layer and a matrix of the ink layer and/or the bonded portions are the same type of resin.

7. The flexible optical fiber ribbon according to claim 6, wherein the thickness of the transparent coating layer is 10 μm to 50 μm.

8. The flexible optical fiber ribbon according to claim 5, wherein a modulus of the transparent coating layer is greater than 500 MPa, and a material of the transparent coating layer is a UV-curable resin, a modulus of the ink layer is greater than 600 MPa, and a material of the ink layer is a UV-curable ink.

9. The flexible optical fiber ribbon according to claim 1, wherein a material of the bonded portions is a photocurable resin, and the bonded portions are continuous or discontinuous in an arrangement direction of the optical fibers.

10. An optical cable, comprising an outer sheath and the flexible optical fiber ribbon according to claim 1, wherein the flexible optical fiber ribbon is accommodated in the outer sheath.
